(19) United States
(12) Patent Application Publication
(10) Pub. No.: US 2017/0312966 A1
(43) Pub. Date: Nov. 2, 2017

(54) DEVICE FOR PRODUCING AND SMOOTHING PLASTIC FILMS OR PLASTIC PLATES

(71) Applicant: STARLINGER & CO GESELLSCHAFT M.B.H., Wien (AT)

(72) Inventors: Jürgen HAINDL, Niederwaldkirchen (AT); Harald HÖLLER, Linz (AT); Markus FELLINGER, Wilhering (AT)

(21) Appl. No.: 15/523,818

(22) PCT Filed: Nov. 2, 2015
(86) PCT No.: PCT/EP2015/075408

§ 371 Date: May 2, 2017

(30) Foreign Application Priority Data
Nov. 3, 2014 (EP) 14191426.7

(51) Int. Cl. B29C 47/00; B29C 47/08; B29C 47/16; B29C 47/88; B29C 47/92; B29C 43/24; B29C 43/58; B29C 47/36

(52) U.S. Cl. CPC B29C 47/004; B29C 43/58; B29C 47/0021; B29C 47/0898; B29C 47/165; B29C 47/367; B29C 47/8845; B29C 47/92; B29C 43/245; B29C 2043/5825; B29C 2043/5875; B29C 2947/92038; B29C 2947/92095; B29C 2947/92104; B29C 2947/92152; B29C 2947/92533; B29C 2947/9259; B29C 2947/92647; B29C 2947/926

(57) ABSTRACT

The smoothing device for plastic films comprises plastic-melt-producing means (1, 5), an adjustable slit die (10) and a roller smoothing unit (16) having cooled smoothing rollers (11, 12), which form an adjustable smoothing gap (13) between each other. Optionally, further rollers (15) are arranged downstream. A thickness gauge (23) measures the thickness of the plastic-film web (22). A controller (30) for controlling the thickness of the plastic-film web (22) may set a setpoint thickness (SD) of the plastic-film web (22) and the volumetric flow rate (SS) of the plastic melt or the line speed (LS). The controller (30) captures the current torques and rotational speeds of the rollers (11, 12, 15) and the current thickness (FD, FD1-FDn) of the plastic-film web (22).

The controller (30) sends setpoint rotational speed signals (C0S, C2S-CnS, CAS) calculated from the captured torques of the rollers (11, 12, 15) to the drives of the rollers and a smoothing-gap setpoint distance signal (GW) for adjusting the smoothing gap (13), and furthermore—in the case of a specified line speed (LS)—setpoint plastic-melt volumetric flow rate signals (SS) to the plastic-melt-producing means, or—in the case of a specified plastic-melt volumetric flow rate (SS)—setpoint line speed signals (LS) to the drives of the rollers (12).

The invention relates to a device for producing and smoothing plastic films or plastic sheets, respectively, according to the preamble of claim 1.

In principle, there has to be distinguished with the production of plastic films and plastic sheets between the calender method and the smoothing method. In a device working according to the known calender method (U.S. Pat. No. 4,372,736), a thick melt strand that is only slightly defined in its geometry is properly rolled into a wide film having a small thickness. For this rolling process, there are required huge delamination loads at the calenders. In order to drive the calender rollers, consequently, there are also required very strong motors and for the transfer of the torques also very strong drive connections. Calenders are mainly suitable for the processing of PVC having a substance-specific material behaviour.

In the production of films and sheets using a smoothing unit, however, the film or the sheet are fed into the smoothing unit already at that geometry that is to be achieved at the end of the process. A film or sheet smoothing process thus is, among others, characterized in that the width of the film or sheet web, respectively, fed into the smoothing unit will not be altered by the smoothing process. As a consequence, a slit die has to be arranged upstream of the smoothing unit, in which a melt flow that is fed is transformed into the geometry of the film or sheet. For the extrusion and both-sided smoothing of plastic films or plastic sheets, respectively, using a smoothing unit, hence, there are commonly used devices, which contain an extruder for extruding thermoplastic materials, a slit die connected thereto and a roller smoothing unit for receiving the extruded web at least between two smoothing rollers that form a roller gap. In order to achieve a constant thickness of the plastic web, there is always maintained a small “supply” of the plastic melt in the form of a ridge upstream the roller gap, being constantly forced outwards. In this way, the roller gap is to be kept permanently filled. It has, however, been shown that this measure does not suffice in order to ensure a constant thickness of the plastic web. In particular with the production of thin plastic films, this measure has proven to be inefficient insofar as the extrusion and smoothing of thin plastic films may only be handled with most careful fulfilment of production conditions, especially by using a slit die having an adjustable exit lip, a so-called “flex lip”. Setting and fulfilling these production conditions, however, requires the staff to have high expert skills and a high level of experience. Nevertheless, in the practice, there will always occur deviations or flaws, which will frequently lead to damage of the roller surfaces due to extreme pressures in the smoothing gap.

In order to overcome these disadvantages, there is proposed in the EP 0 652 995 B1 a device for the extrusion of plastic films, including an extruder for the extrusion of thermoplastic materials, a slit die connected thereto and a roller smoothing unit, which has at least two smoothing rollers forming a roller gap for receiving the extruded film web, wherein at least one roller of the smoothing unit is slidably mounted on the side plates of the smoothing unit in a nearly friction-free way and is arranged vertically to the contact plane of the roller gap, spring-loaded by alteration of the axial distance to the other roller. This device is still based on the theoretical and in the practice not to be sufficiently fulfilled assumption that the melt web enters the smoothing gap at a nearly constant thickness and, hence, no high line forces are being required in order to completely smooth the surface but rather the clear width of the roller gap of the smoothing unit is automatically adjusted by the thickness of the entering film web, by at least one roller being moved. Transient alterations of the thickness of the film web due to irregularities within the melt flow are deliberately accepted, and it is stated that in the case of elimination of these irregularities in the melt flow, the roller will return, thus remaining permanently in contact with the plastic web in this way. Measures for actively controlling the thickness of the plastic film are not provided by the EP 0 652 995 B1.

In order to keep the film thickness constant in the production of films (or sheets) in film extrusion devices or also in order to being able to control this during production, there have been presented various concepts.

In the DE 3531005 C2 there is, for example, described a system, in which the film thickness is determined during production by a thickness gauging system and the determined thickness deviations are compensated for by controlling the die gap width. This system, however, is not able to react to thickness variations of the film, which are the result of deviations of the smoothing gap width caused by stress alterations.

This problem could be solved by the invention described by the EP 889776 B1, wherein a smoothing gap may additionally be controlled by changing the ridge of the roller mantle. It is, however, disadvantageous that, for this purpose, the rollers have to be provided with a complicated and expensive controller for the roller mantle.

Controlling the smoothing gap width during production is described in the documents US 2007/045885 A1 and US 2006/260484 A1. The systems disclosed therein are constructed such that the smoothing gap may be set via a linearly and/or a pivotably movable smoothing roller. The smoothing gap width set in this way is changed dependent on the pressure of the plastic melt, requiring a constant measurement of the smoothing gap width in order to maintain this gap constant by means of this control. Any deviations of the smoothing gap width along an axial direction of the smoothing rollers have to be compensated for by a permanent adjustment of the two smoothing rollers to each other. For controlling, these two systems assume that the plastic melt flowing through the smoothing gap changes (increases or decreases) the width of the smoothing gap as a function of the momentary melt volume, which is why the actual width of the smoothing gap has to be permanently measured.

The document DE 26 39447 A1 describes an assembly of smoothing rollers pivotable about a rotational axis. In this way, the thickness homogeneity of different plastic films is to be improved. A dynamic control or adjustment during production is not possible with the system described.

An improvement of the thickness homogeneity of extruded and smoothed plastic films is also described in the U.S. Pat. No. 4,810,179 A. The individual smoothing rollers may be pressed against each other by means of hydraulic cylinders via pivoting arms, wherein the associated delamination load may be determined by measuring the loads acting on the cylinders and the mechanical stops. As a function of the determined delamination load, the stripping rate is adjusted. A dynamic control or adjustment during production is not described and, hence, does not appear to be possible.

In the EP 0 429 161 A1 there is described a system, in which the film thickness is captured indirectly by way of comparative temperature measurement of the plastic melt upstream of the smoothing gap and of the film downstream of the smoothing gap and the conclusions drawn therefrom for the ridge characteristics of the film. In this system, there will be affected, among others, the melt extruder, a melt pump and the rotational speed of the rollers. This method is disadvantageous insofar as it is not applicable on all thermoplastic materials as some of these materials, in particular polyethylene terephthalate, cool down rapidly at the surface, which would be optically visible in the film produced.

The invention is now based on the task to provide a device for producing and smoothing plastic films and plastic sheets, wherein the thickness of a film web or sheet web made from thermoplastic material may be controlled during operation in an automated and exact way and the disadvantages explained above regarding prior art are overcome.

This task is solved by providing a device for producing and smoothing plastic films or plastic sheets, respectively, having the features of claim 1. Advantageous embodiments of the invention are described in the subclaims and in the embodiment examples.

In contrast to the documents US 2007/045885 A1 and US 2006/260484 A1, the control according to the invention is based on capturing the torque of the roller(s), and the width of the smoothing gap is specified according to the invention by the application of sufficiently high contact pressing loads and it is not continuously measured. In the US 2007/045885 A1 the control is further based on capturing the pressing load acting on the rollers but not on capturing the roller torques. In contrast thereto, the set width of the smoothing gap may be assumed as being constant in the present invention due to the exertion of sufficiently high pressing loads, which may not be overcome by the melt flow in the sense of widening of the smoothing gap, which is why an adjustment of the thickness of the film may be realized by means of the torque exerted on the roller(s). Similarly, the document EP 0 429 161 A1 discloses, apart from the control that is in principle of a different configuration, not a detection and control of the roller torque but rather a detector for measuring the forces (loads) exerted by the melt in the smoothing gap. The subject matter of the present invention, in turn, does not have such a detector.

The device according to the invention for producing and smoothing plastic films or plastic sheets, respectively, comprises:
plastic-melt-producing means for producing a plastic melt from a thermoplastic material, a slit die having two die lips adjustable in their distance to each other, which form a die gap between one another, wherein the slit die may be supplied with plastic melt from the plastic-melt-producing means,

a roller smoothing unit having two smoothing rollers, of which at least one is cooled, which form between one another an adjustable smoothing gap for receiving the flow of plastic melt discharged by the slit die, wherein the smoothing rollers cool down the flow of plastic melt until solidification thereof as a plastic-film or plastic-sheet web, thereby smoothing the surfaces, wherein optionally there is arranged downstream of the smoothing rollers at least one cooling roller contacting the plastic-film or plastic-sheet web;

at least one thickness gauge for measuring the thickness of the plastic-film or plastic-sheet web, which is arranged downstream of the smoothing rollers and optionally of the at least one cooling roller;

an optional stripping device, which is preferably configured as a stripping roller pair for stripping the plastic-film or plastic-sheet web or as a winding unit.

This device has a controller for controlling the thickness of the plastic-film or plastic-sheet web, wherein the controller has setpoint inputs for setting the setpoint thickness of the plastic-film or plastic-sheet web and for setting either the volumetric flow rate of the plastic melt discharged by the plastic-melt-producing means or for setting the line speed.

The controller further has actual value inputs
for capturing the current torque of at least one roller, preferably of all rollers, and optionally of the winding unit;
for capturing the rotational speed or circumferential speed of at least one roller, preferably of all rollers; and
for capturing the current thickness of the plastic-film or plastic-sheet web measured by the thickness gauge.

The controller also has control signal outputs, by way of which it
sends setpoint rotational speed signals or setpoint circumferential speed signals calculated from the captured current torques of the rollers to the drives of the rollers;
outputs a smoothing-gap setpoint distance signal calculated from the setpoint thickness and the captured current torques of the rollers for adjusting the smoothing gap; and
sends either—in the case of a specified line speed—setpoint plastic-melt volumetric flow rate signals calculated from the setpoint thickness and the current thickness of the plastic-film or plastic-sheet web to the plastic-melt-producing means
or—in the case of a specified plastic-melt volumetric flow rate—setpoint line speed signals calculated from the setpoint thickness or the current thickness of the plastic-film or plastic-sheet web and/or setpoint circumferential speed signals derived therefrom to the drives of the rollers.

The term “films” usually means plastic webs having a thickness of up to 3 mm. The films are usually wound up into rolls for later use. The term “sheets” means plastic webs having a thickness of usually between 1 and 15 mm, which in the course of the production process are cut into individual parts and stapled for later use. The films or sheets may be mono-layered or multi-layered and consist of the same or different plastic materials. It is, hence, to be understood that plastic films as well as plastic sheets may be produced from a plastic web. For the sake of brevity, the term plastic film or film in the following specification sometimes also incorporates a plastic sheet.

The device according to the invention is adapted for processing thermoplastic materials. The material to be processed comprises in particular thermoplastic polyesters, polyolefins, polyvinylchloride, PET, Virgin material and recycling material, e.g., flakes made from shredded plastic bottles, wherein this material may optionally be pre-treated, e.g., in a SSP reactor, and it may also be supplied in the form of pellets or granules, respectively. Also a so-called “regrind” material, i.e. waste from the running production such as, e.g., cut-off edge strips, or material from a previous production, may be re-supplied to the device according to the invention. As far as in the following specification the terms plastic melt, melt, plastic web, plastic film, plastic sheet, film or sheet are used, there is designated thereby a product of the mentioned thermoplastic materials.

The term “smoothing” in the present invention also includes the conversion of an uncontrollable web surface into a desired surface structure.

In a preferred embodiment of the invention, which produces high-quality products, the controller adjusts, at the specified plastic-melt volumetric flow rate, the smoothing-gap setpoint distance signal and the control signals for the line speed or the control signals for the circumferential speeds or rotational speeds, respectively, of the rollers such that the torque of at least one of the rollers, preferably of all of the rollers, and optionally of the winding unit, is below a maximum torque and optionally also above a minimum torque. As an alternative to this embodiment, the controller adjusts, at a specified line speed, the control signal for the plastic-melt volumetric flow rate and the control signals for the circumferential speeds or rotational speeds for those rollers, and optionally for the winding unit, with the exception of that roller, the circumferential speed of which defines the measure for the line speed, such that the torque of at least one of the rollers, preferably of all of the rollers, and optionally of the winding unit, is below a maximum torque and optionally also above a minimum torque.

According to the invention, the die gap adjustment device may be actuated either manually or in an automated way, or it may include a manual basis adjustment and an automated fine adjustment. In a further embodiment of the invention the setpoint inputs of the controller include the adjustment of the tensile load of the winding unit, wherein the controller also takes these into account when calculating the control signals.

In the device according to the invention the plastic-melt-producing means comprises at least one extruder, in particular a single-screw extruder, a double-screw extruder or a multi-screw extruder, and/or at least one melt reactor having a discharge pump.

If in the device according to the invention there is/are connected a filter and/or a melt pump between the plastic-melt-producing means and the slit die, then the melt may be purified and it is possible to obtain a constant definable melt volumetric flow rate as well as a stabilization and increase of the melt pressure.

In order to increase the accuracy of the setting of the die gap, in one embodiment of the invention the slit die is divided along the width thereof into several zones, in which the respective sections of the die lips may be adjusted individually in distance to each other.

A very accurate adjustability may be obtained if there are arranged temperature-controllable expansion bolts distributed along the width of the slit die for adjusting the distance of the die lips or die lip sections, the length of which varies with the temperature thereof, wherein the expansion bolts are attached, on the one side, at a die lip and, on the other side, at a fixed machine part.

In an alternative embodiment also offering very accurate adjustability, there are provided threaded bolts that may be adjusted by a motor and that are distributed along the width of the slit die for adjusting the distance of the die lips or the die lip sections, wherein each threaded bolt is associated with a controlled motor, or there is provided a movable motor, which is movable in an automated way from threaded bolt to other threaded bolt, successively adjusting one after the other.

The adjustability is further improved if a smoothing roller of the smoothing roller pair forming the smoothing gap is mounted on a movable lever, which may be pivoted by an actuator about a pivot point. There may be applied a high torque to the pivot point of the lever if the actuator moving the lever is configured as a pneumatic or a hydraulic cylinder or as a rotational drive. This torque is higher than the counter-torque resulting from the smoothing gap.

In an alternative embodiment a smoothing roller of the smoothing roller pair forming the smoothing gap is slidable in a linear way. The formation of a defined smoothing gap is facilitated if the pivoting area of the lever or the linear slidability of the smoothing roller, respectively, is limited by an adjustable stop, wherein the adjustable stop is preferably a rotationally mounted solid body, the thickness of which, i.e. the distance of the external surface of the solid body to the rotational axis, is a function of the torsion angle of the solid body. The solid body may be configured as an eccentric having an annular, elliptical or a more complex circumferential curve.

Due to safety reasons, there is made provision in one embodiment of the invention to limit the pivoting range of the lever or the linear slidability of the smoothing roller, respectively, by an adjustable stop. The adjustable stop is configured as a spindle drive.

The thickness gauge may be configured as a stationary thickness gauge, which measures the thickness of the plastic-film or plastic-sheet web across the entire width thereof or only in a partial area. In order to capture the transverse thickness profile of the film, the thickness gauge is configured either as a stationary thickness gauge, which is divided into several measurement zones and which measures the thickness of the plastic-film or plastic-sheet web section-wise across the entire width thereof, or the thickness gauge is configured as a thickness gauge traversing the width of the film. The thickness gauge may have capacitive or inductive sensors, optical sensors, sensors, which determine the distance of the film surface to a deflecting roller, or X-ray transmission sensors.

The invention is now described in greater detail in an exemplary form by way of not-limiting embodiments in reference to the drawings.

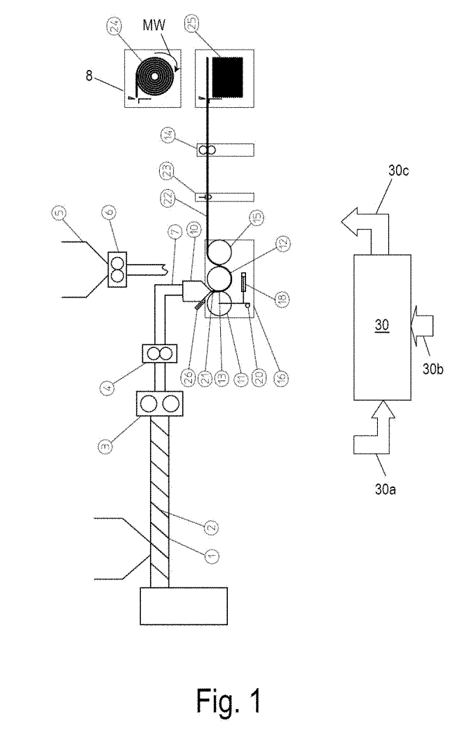

FIG. 1 shows a process scheme of an production device according to the invention for producing and smoothing films and/or sheets made from a thermoplastic material in a side view;

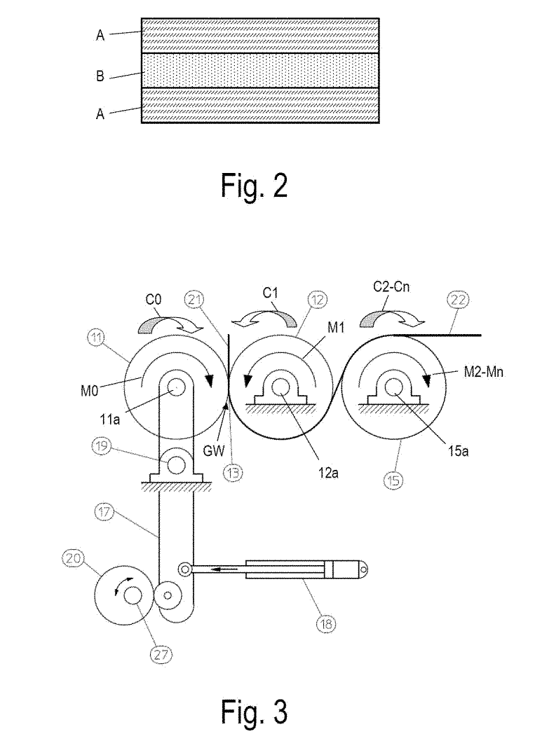

FIG. 2 shows the setup of a multi-layered film made from a thermoplastic material in the material sequence A-B-A produced using the production device according to the invention;

FIG. 3 shows an advantageous setup of a smoothing unit of the production device according to the invention;

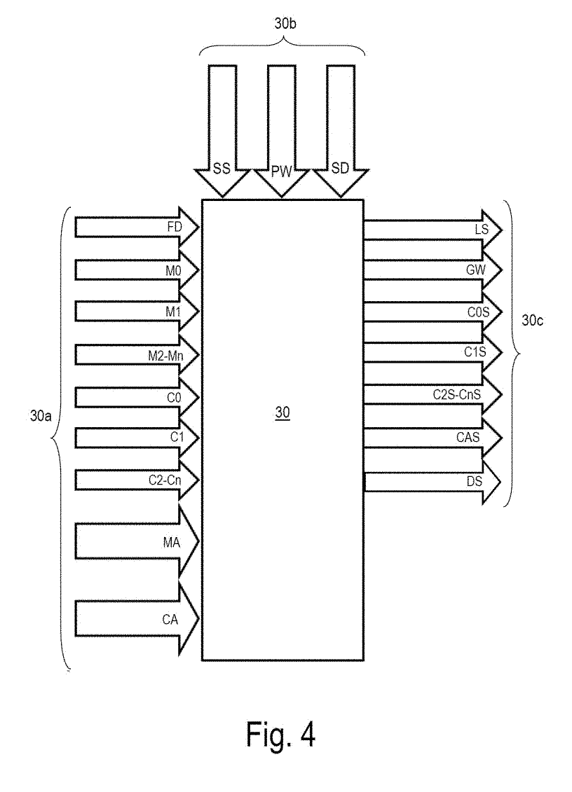

FIG. 4 shows a diagram of a controller used in the production device according to the invention having the control parameters at a specified material discharge;

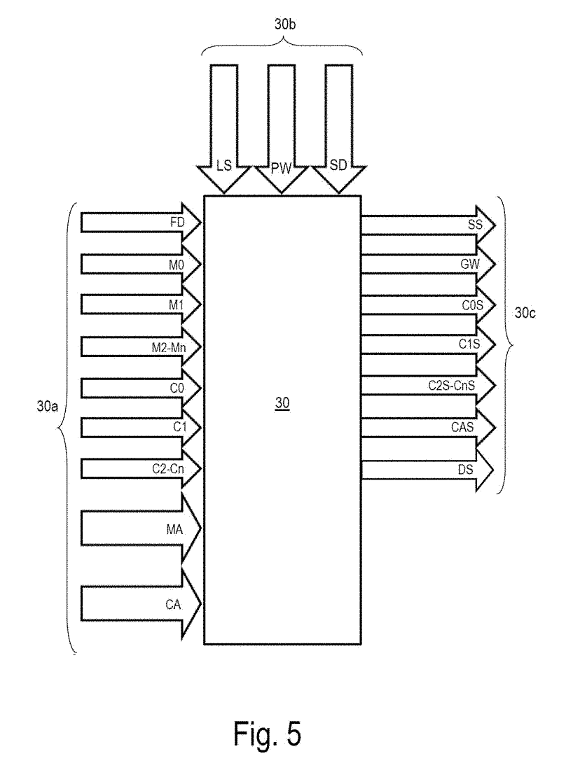

FIG. 5 shows a diagram of an alternative controller used in the production device according to the invention having the control parameters at a specified line speed;

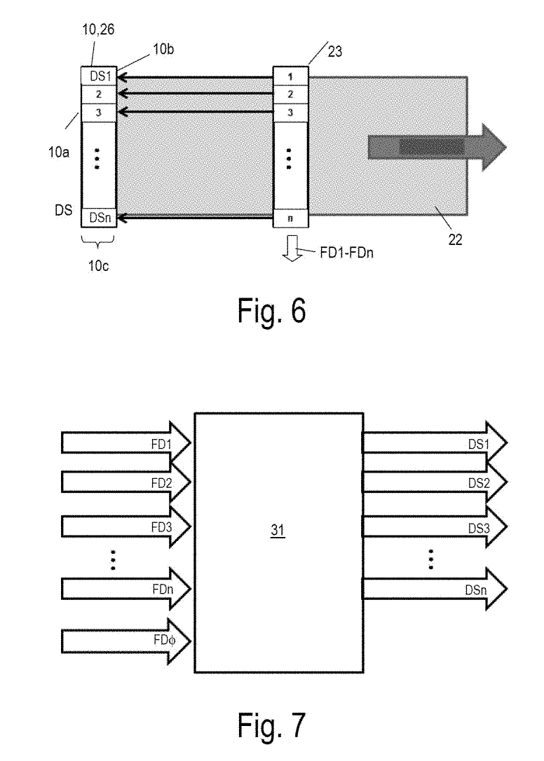

FIG. 6 shows a scheme of a transverse profile control of the die gap of a slit die used in the production device according to the invention in a top view;

FIG. 7 shows a diagram of the control parameter of the transverse profile control of FIG. 6; and

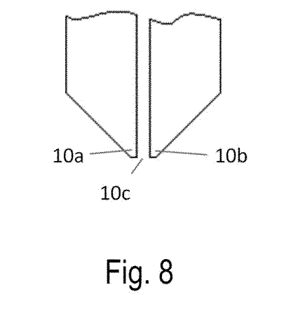

FIG. 8 shows the adjustable die gap.

An embodiment of an device for producing and smoothing plastic films and/or plastic sheets from thermoplastic materials according to the invention is schematically depicted in FIG. 1 and is now described in greater detail. In order to prevent repetition of wording, reference is usually made to plastic films. It is, however, to be noted that the production device is also designed for plastic sheets.

The device for producing and smoothing plastic films and/or plastic sheets has plastic-melt-producing means in the form on an extruder (1), to which the thermoplastic starting material is supplied to. The extruder (1) is a single-screw extruder, a double-screw extruder or a multi-screw extruder. The plastic material is heated in the extruder (1) and conveyed by means of one or several screws (2) in the direction of the extruder exit, thereby being compressed, molten, homogenized and optionally degassed. Downstream of the extruder exit, there is situated an optional filter (3) for purifying the melt, as well as optionally a melt pump (4) in order to obtain a constant and definable plastic-melt volumetric flow rate. The melt pressure is further stabilized and increased by the melt pump (4).

Alternatively or additionally to the extruder (1), the plastic-melt flow required for the plastic film production may be produced in a melt reactor (5) and removed by means of a discharge pump (6).

If there are provided several extruders (1) and/or melt reactors (5), in particular for the production of multi-layered plastic films or plastic sheets, respectively, (see FIG. 2), then there follows a feeding block (7), which combines the supplied melt flows into a single exiting melt flow, wherein the separation is realized on the basis of a specified ratio, e.g., A/B/A=10/80/10, if applies: A=discharge co-extruder, B=discharge main extruder and the ratio of A/B=20/80.

The plastic melt thus produced is then guided into a slit die (10). The plastic flow (21) exiting the slit die (10) has a similar cross-section to that of the finished film/sheet. The exiting volumetric flow rate may be controlled by dosing, the extruder (1) or the melt pump (4), respectively, wherein the setpoint value is specified by the subsequently described thickness control.

In the die (10) the distance of the die lips (10a, 10b) to each other may be set (=die gap 10c), see FIG. 6 and in particular FIG. 8. This may solved by means of various concepts. One concept provides for the manual setting of the die gap 10c. Another concept provides for a manual basis adjustment of the die gap 10c and an automated fine adjustment, which results in total in a limited area that may be adjusted in an automated way. A third concept provides for an automated adjustment of the die gap 10c across the entire area, whereby no manual (basis) adjustment is required but the entire die gap adjustment is realized in an automated way. In all concepts, the die gap (10c) may be uniformly adjusted across the entire width, or the die width is divided into several zones (1 to n), in which the respective sections of the die lips (10a, 10b) may be individually adjusted. In a preferred embodiment, there are arranged heated expansion bolts (26) in regular intervals across the entire die width, the length of which varying with the heating performance introduced therein. In this way, the expansion bolts (26) are, on the one side, attached to a die lip and, on the other side, at a fixed machine part such that, as a function of the temperature-independent length of the expansion bolts (26,) the die gap in the respective area will be increased or decreased. As an alternative, instead of the expansion bolts there may also be attached threaded bolts, with the die gap being adjusted by means of appropriately controlled motors. It may also be conceived that there is one motor per threaded bolt, or only one, which is moved in an automated way from one bolt to the other one, thus successively adjusting one after the other.

The melt (21) exiting the die (10) is smoothed between two counter-rotating smoothing rollers (11, 12), of which at least one is cooled, preferably that smoothing roller (12), which is in part surrounded by the film web (22). Most preferably, however, both smoothing rollers (11, 12) are cooled. The smoothing rollers (11, 12) are spaced apart from each other by a distance (13), the so-called smoothing gap, which is specified by the thickness control and which may be changed in an automated way during running operation. Downstream of the smoothing rollers (11, 12) there is optionally arranged at least one cooling roller (15), which may be in part surrounded by the smoothed film web (22). According to requirements, the at least one optional cooling roller (15) may be arranged directly at the smoothing unit, such as, e.g., the roller 15 in the FIGS. 1 and 3, or it may be provided downstream of the smoothing unit as a separate post-cooling unit. The cooling roller (15) and the smoothing rollers (11, 12) of the smoothing unit (16) are flown through by a temperature-controlling medium (e.g. water having a determined glucose content, e.g. cooling water from an open or closed cooling circuit), thus being controlled to a specified temperature. Each smoothing roller and optionally also cooling roller has an individual controlled drive (11a, 12a, 15a), preferably configured as described in the EP patent application no° 13167232.1. Other embodiments of controlled drives, which meet the indicated requirements and are known to those skilled in the art, may also be used. As examples are to be noted asynchronous motors or synchronous motors with or without feedback. For each controlled roller drive, the rotational speed and the circumferential speed as well as the maximum acceptable torque may be specified. As actual values there are captured the current rotational speed or the circumferential speed and the current torque of the roller drives. The smoothing unit (16) may, if required, additionally to the two smoothing rollers (11,12) further include several deflecting rollers and a stripping device in the form of a stripping roller pair (14) designated as “stripping duo”, between which the cooled film web (22) is stripped off under friction-fit. In order to increase the cooling performance, there may be provided further cooling rollers (15) with or without drive, which are in part surrounded by the plastic film web (22). Driven cooling rollers (15) may, for example, be realized having a servo drive or asynchronous motors.

The stripping roller pair (14) is intended to keep the film web (22) from the smoothing unit (16) across the cooling roller(s) under tensile load and usually comprises rubber-coated metal rollers, wherein also a variant having one rubber-coated and one not-rubber-coated roller is possible. At least one rubber-coated roller is driven by a controlled roller drive. The controlled drive of the stripping roller pair (14) is realized by a servo drive, for which the speed and the maximum torque are specified and from which as actual values the current rotational speed or the circumferential speed and the current torque are read. There may also be used an asynchronous motor with or without impulse transmitter as a drive for the stripping roller pair.

The adjustability of the smoothing gap (13) may, for example, be realized—as shown in FIG. 3—by a smoothing roller (11) of the smoothing roller pair (11, 12) forming the smoothing gap (13), which is preferably that smoothing roller, which is not surrounded by the film web (22), being mounted on a movable lever (17). This lever (17) may be pivoted by means of an actuator (18) about a pivot point (19). The pivoting range of the lever (17) may be limited by an adjustable stop (20, 27), which results in a defined smoothing gap (13). The adjustable stop (20, 27) may, for example, be a rotationally mounted solid body (20), the thickness of which—i.e. the distance of the external surface to the rotational axis (27)—is dependent of the torsion angle. As simplest embodiment there is mentioned herein the eccentric (20) having an annular circumference and a rotational axis offset from the centre. There may, however, also be provided elliptical circumferences and more complex circumferential curves. The actuator (18), which moves the lever (17), is preferably configured as a pneumatic or hydraulic cylinder. There may also be provided other alternative actuators, which apply an appropriately high torque on the pivot point (19) of the lever (17), such as rotational drives. According to the position of the eccentric (20), in this way a certain width of the smoothing gap (13) is adjusted. The eccentric (20) is positioned using a servo-drive, wherein the conversion tables provided in the control device or the corresponding conversion formula, respectively, between smoothing gap (13) and eccentric position are taken into account. A basic prerequisite in this setup is that the torque about the rotational point (19), which torque resuls in the smoothing gap (13) from the load generated by the plastic melt (21) and the plastic-melt ridge forming upstream of the smoothing gap, is smaller than the counter-torque generated by the actuator (18), in order ensure that the eccentric (20) is in contact with the lever (17). Alternatively to the eccentric (20), also other approaches may be selected in order to change the position of the stop, such as heated expansion bolts. This device may be present on both sides in order to independently adjust the smoothing gap (13) of each side. It is, however, also conceivable to make this mechanism in a simple configuration and to adjust both sides together.

In alternative embodiments the smoothing gap (13) may be positioned by means of other mechanical constructions, e.g. by means of a horizontal spindle having a small inclination, which is positioned by means of a servo drive; or by means of a wedge-like stop, slidable by servo-motor control in a translational motion. It is important that the smoothing gap (13), independently of the load and generated by the plastic melt (21) or the resulting melt ridge, remains constant in the smoothing gap (13) according to the value specified by the controller.

If the discharge of plastic melt from the plastic-melt-producing means (1, 5), the width of the die gap, the width of the smoothing gap (13) and the roller speeds are not selected appropriately, this will result in a lower quality of the film (22) or the film surface, respectively, as too much or too little material is accumulated at least in some spots upstream of the smoothing gap (13).

If there is accumulated too much material, then there is formed a plastic melt ridge, which consequently leads to a “ridge protrusion”, if this plastic melt ridge is pressed through the smoothing gap. This ridge protrusion is visible in the finished film (22). As a further consequence thereof, the torques of the smoothing roller drives increase. In the worst case, the resulting torque exceeds the maximum torque of the drive, thereby blocking the smoothing roller and stopping the entire production.

If (in some spots) too little material enters the smoothing gap (13), the plastic melt in this area is not in contact with the two cooling rollers (11, 12). This leads to the film (22) in this area not being appropriately cooled and smoothed, which will be visible in the finished film. This may even result in the film (22) sagging in this area and, in the further advancement of the film web, e.g., in the area of the ripping duo or at other narrow points, getting stuck or tearing. It may also happen that the film (22) becomes brittle in the area of the thin spot due to insufficient cooling and, in the further advancement within the plant, then breaks. It is also possible that the film (22) has holes due to insufficient melt supply, which leads to production residuals to be discarded.

Downstream of the smoothing unit (16) there are arranged various devices for inspection of the film quality, namely a thickness gauge (23), optionally also colour measuring devices, a camera system, etc. According to the requirements, these may be stationary and may also monitor only a part of the width of the film, or they may monitor the entire width of the film or they may transverse across the width of the film, thus monitoring the entire width of the film. According to the requirement, there may be arranged further stations, which, e.g., apply silicone or laminate a further film onto the produced plastic film or sheet.

At the end of the production device, the edges of the plastic film or sheet are usually cut off, and the film is wound up into rolls (24) in a winding unit (8). In the production of sheets (25), these are cut and stapled. The winding unit (8) may alternatively or additionally to the stripping roller pair (14) also act as a stripping device.

The thickness and the quality of the plastic films and sheets is decisively dependent on the following factors or on the way these are harmonized, respectively:
melt flow, this is the volumetric flow rate of plastic melt that exits the slit die;
width of the die gap, set by means of threaded bolts, expansion bolts, etc.
width of the smoothing gap
roller speeds (and the film speeds resulting therefrom)
intrinsic viscosity (iV-value) of the melt flow

These parameters are usually set, adjusted and changed by the operator of the production plant in order to obtain a film having the required quality. The result, hence, has been significantly dependent on the operator's skills.

In FIG. 3, the reference numeral C0 designates the circumferential speed of the smoothing roller (1), which is not surrounded by the plastic-film web (22). The reference numeral C1 indicates the circumferential speed of the smoothing roller (12), which is in part surrounded by the plastic-film web (22). The reference numerals C2 to Cn indicate the circumferential speeds of optional cooling rollers (15), which may be necessary in particular in the production of thicker films/sheets for further cooling of the plastic-film web.

The circumferential speed C1 of the smoothing roller (12) surrounded by the plastic-film web is also designated as “line speed”, as it represents the reference speed on which all rotational speeds of the entire plastic film or plastic sheet production device (=line) are dependent (either as an offset or a percentage).

The term “web speed” designates the resulting speed of the cooled entire plastic-film web or plastic sheet web, respectively. The web speed may not be accurately determinable due to slippage, shrinkage of the plastic web (during the cooling process) and other influences and is thus not used for the control according to the invention.

It is the aim of this invention to realize a control, which controls the quality of the films or sheets, respectively, in a completely automated way and, in this way, reduces the influence the professional experience and skills of the operating person has on the quality of the finished products.

For this purpose, the invention provides, as schematically depicted in the FIGS. 4 and 5, a controller (30) for controlling the thickness of the plastic-film or plastic-sheet web, having setpoint inputs (30b), actual value inputs (30a) and control signal outputs (30c).

The setpoint value inputs (30b) are intended to set the setpoint thickness (SD) of the plastic-film or plastic-sheet web (22) and to set either the volumetric flow rate (SS) of the plastic melt supplied by the plastic-melt-producing means (see FIG. 4) or to set the line speed (LS) (see FIG. 5) by an operating person. Optionally, also a setpoint value input may be intended for adjusting the tensile load (PW) of the winding unit (8).

The actual value inputs (30a) are intended to capture the torques (M0, M1, M2-Mn, MA, MW) of the smoothing rollers (11,12), of the optional cooling rollers (15) and the stripping roller pair (14), and optionally of the winding unit (8); further to capture the rotational speeds or circumferential speeds (C0, C1, C2-Cn, CA) of the smoothing rollers (11,12), the optional cooling rollers (15) and the stripping roller pair (14), and to capture the current mean thickness (FD) of the plastic-film or plastic-sheet web (22) measured by the thickness gauge (23). It is to be noted that the circumferential speed (C1) of the smoothing roller (12) defines the line speed (LS).

Via the control signal outputs (30c), the controller (30) sends setpoint rotational speed signals or setpoint circumferential speed signals to the drives (11a, 12a, 15a) of the smoothing rollers (11,12), the optional cooling rollers (15) and the stripping roller pair (14), further smoothing-gap setpoint distance signals (GW) for adjusting the smoothing gap (13) to the actuator (18). If the line speed (LS) is specified (FIG. 5), the controller (13) sends setpoint plastic-melt volumetric flow rate signals (SS) to the plastic-melt-producing means, which control the melt discharge thereof accordingly. If the plastic-melt volumetric flow rate (SS) is specified (FIG. 4), then the controller (30) generates setpoint line speed signals (LS) and setpoint circumferential speed signals (C0S, C1S, C2S-CnS, CAS) derived therefrom or setpoint rotational speed signals to the controlled drives (11a, 12a, 15a) of the smoothing rollers (11,12), the optional cooling rollers and the stripping roller pair (14). It is to be noted that the setpoint signal of the line speed (LS) is equal to the setpoint circumferential speed signal (C1) of the smoothing roller (12), as it is the circumferential speed (C1) of the smoothing roller (12) that defines the line speed (LS), which is why it is sufficient to send only one of the two signals.

The control signals mentioned are calculated by the controller (30) by periodically comparing, at a specified plastic-melt volumetric flow rate (SS), the current thickness of the plastic-film or plastic-sheet web with the setpoint thickness, by thereon examining the torque of at least one of the rollers (11, 12, 14, 15), preferably all of the rollers, in regard to whether it is below a maximum torque and optionally also above a minimum torque, and by comparing the actual circumferential speed (C0, C1, C2-Cn, CA) or the actual rotational speeds of at least one roller, preferably of all rollers, with the setpoint circumferential speed or the setpoint rotational speed and therefrom generating the control signals for the line speed (LS) and derived therefrom the control signals for the circumferential speeds or rotational speeds of the rollers as well as the control signal for the smoothing gap. Optionally, also the load, by way of which the winding unit (8) pulls the film, is taken into account by the controller for calculation.

If the line speed (LS) is specified, the controller (30) calculates the control signals by periodically comparing the current thickness of the plastic-film or plastic-sheet web with the setpoint thickness, by thereon examining the torque of at least one of the rollers (11, 12, 14, 15), preferably all of the rollers, in regard to whether it is below a maximum torque and optionally also above a minimum torque, and by comparing the actual circumferential speed (C0, C1, C2-Cn, CA) or actual rotational speeds of at least one roller, preferably of all rollers, with the setpoint circumferential speed or the setpoint rotational speed. From these comparisons, the controller (30) generates the control signal for the plastic-melt volumetric flow rate (SS) as a setpoint value for the control of the discharge of plastic melt by the plastic-melt-producing means (1, 5), further the control signals for the circumferential speeds or the rotational speeds of the rollers as well as the control signal for the smoothing gap. Optionally, also the load, by way of which the winding unit (8) pulls the film, is taken into account by the controller for calculation.

In FIG. 6, there is shown a scheme of a transverse profile control of the die gap of an automated slit die. FIG. 7 shows a diagram of the control parameters of this transverse profile control of FIG. 6. The thickness gauge (23) provides for the zones (1-n) a thickness profile (FD1-FDn) of the film web (22) transversely to the film web direction. According to the number of data points across the width of the film web, before the further processing, the raw data are averaged in a way such that there are obtained as many mean values as control zones of the die gap adjustment device (26). A controller (31), which may be part of the controller (30), compares these with a mean thickness of the entire film web (22) and outputs corresponding setpoint values (DS, DS1-DSn) to the die gap adjustment device (26). In order to adjust the die gap, there are provided various concepts, e.g. by means of heated expansion bolts, eccentric, driven threaded bolts, etc. for each zone.

In order to measure the film thickness (FD), there may be used most varied sensors, such as capacitive-inductive sensors, optical sensors or other measurement methods/sensors, which determine the distance of the film surface to a deflecting roller. Further there may be used, e.g., X-ray transmission sensors, which directly measure the film thickness. In order to obtain appropriately many measuring points, the thickness gauge (23) or the sensor thereof, respectively, may be moved on a guiding transversely to the film web direction, i.e. traversed, thus recording a thickness profile. There may, however, also be used several other stationary thickness gauges (23) or sensors, respectively, that are arranged across the web width.

1. A device for producing and smoothing plastic films or plastic sheets, respectively, comprising
plastic-melt-producing means for producing a plastic melt from a thermoplastic material,
a slit die having two opposing die lips that are adjustable in the distance to each other, which form a die gap between each other, wherein the slit die may be supplied with plastic melt from the plastic-melt-producing means,
a roller smoothing unit having two smoothing rollers, of which at least one is cooled, which form an adjustable smoothing gap between each other for receiving the flow of the plastic melt discharged by the slit die, wherein the smoothing rollers cool the flow of the plastic melt down to the solidification thereof as a plastic-film or plastic-sheet web, thereby smoothing the surfaces;
at least one thickness gauge for measuring the thickness of the plastic-film or plastic-sheet web, which is arranged downstream of the smoothing rollers;
and
a controller for controlling the thickness of the plastic-film or plastic-sheet web, wherein the controller has setpoint value inputs:
for setting the setpoint thickness of the plastic-film or plastic-sheet web; and
for setting either the volumetric flow rate of the plastic melt discharged by the plastic-melt-producing means or for setting the line speed,
wherein the controller has actual value inputs
for capturing the current torque of at least one roller;
for capturing the rotational speed or the circumferential speed of at least one roller; and
capturing the current thickness of the plastic-film or plastic-sheet web measured by the thickness gauge,
wherein the controller has control signal outputs, by way of which
the controller sends setpoint rotational speed signals or setpoint circumferential speed signals calculated from the captured current torques of the rollers to the drives of the rollers;
the controller outputs a smoothing-gap setpoint distance signal calculated from the setpoint thickness and the captured current torques of the rollers for adjusting the smoothing gap, and
the controller sends either—in the case of a specified line speed—setpoint plastic-melt volumetric flow rate signals calculated from the setpoint thickness or the actual thickness of the plastic-film or plastic-sheet web to the plastic-melt-producing means,
or—in the case of a specified plastic-melt volumetric flow rate—setpoint line speed signals calculated from the setpoint thickness and the actual thickness of the plastic-film or plastic-sheet web and/or setpoint circumferential speed signals derived therefrom to the drives of the rollers.

2. A device according to claim 1, wherein the controller, in the case of a specified plastic-melt volumetric flow rate, adapts the smoothing-gap setpoint distance signal and the control signals for the line speed or the control signals for the circumferential speeds or rotational speeds of the rollers, respectively, such that the torque of at least one of the rollers, is below a maximum torque and optionally also above a minimum torque.

3. A device according to claim 1, wherein the controller, in the case of a specified line speed, adapts the control signal for the plastic-melt volumetric flow rate and the control signals for the circumferential speeds or the rotational speeds for those rollers, and for the winding unit, with the exception of that roller, the circumferential speed of which defines the measure for the line speed, such that the torque of at least one of the rollers, and of the winding unit, is below a maximum torque and also above a minimum torque.

4. A device according to claim 1, wherein the die gap adjusting device may be actuated either manually or in an automated way or that it provides for a manual basic adjustment and an automated fine adjustment.

5. A device according to claim 1, wherein the setpoint value inputs of the controller comprise the adjustment of the tensile load of the winding unit and that the controller takes these into account when calculating the control signals.

6. A device according to claim 1, wherein the plastic-melt-producing means comprises at least one extruder, in particular a single-screw extruder, a double-screw extruder or a multi-screw extruder.

7. A device according to claim 1, wherein the plastic-melt-producing means have at least one melting reactor having a discharge pump.

8. A device according to claim 1, wherein a filter and/or a melt pump is/are connected in-between the plastic-melt-producing means and the slit die.

9. A device according to claim 1, wherein the slit die is divided along the width thereof into several zones, in which the respective sections of the die lips may be individually adjusted in the distance to each other.

10. A device according to claim 1, wherein there are arranged temperature-controllable expansion bolts distributed along the width of the slit die for adjusting the distance of the die lips or the die lip sections, the length of which varying with the temperature thereof, wherein the expansion bolts are attached, on the one side, at a die lip and, on the other side, at a fixed machine part.

11. A device according to claim 1, wherein there are provided threaded bolts, which are adjustable by a motor and distributed along the width of the slit die, for adjusting the distance of the die lips or the die lip sections, wherein a controlled motor is assigned to each threaded bolt or wherein there is provided a movable motor, which may be moved from threaded bolt to threaded bolt, successively adjusting one after the other.

12. A device according to claim 1, wherein a smoothing roller of the smoothing roller pair forming the smoothing gap is mounted on a movable lever, which may be pivoted by an actuator about a pivot point.

13. A device according to claim 1, wherein a smoothing roller of the smoothing roller pair forming the smoothing gap is slidable in a linear way.

14. A device according to claim 12, wherein the pivoting range of the lever or the linear slidability of the smoothing roller, respectively, is limited by an adjustable stop, wherein the adjustable stop is a rotatably supported solid, the thickness of which, this is the distance of the external surface of the solid body to the rotational axis, being dependent on the torsion angle of the solid body.

15. A device according to claim 12, wherein the pivoting range of the lever or the linear slidability of the smoothing roller is limited by an adjustable stop, which is configured as a spindle drive.

16. A device according to claim 12, wherein the actuator, which moves the lever, is configured as a pneumatic or a hydraulic cylinder or as a rotational drive, which is larger than the counter-torque resulting from the smoothing gap.

17. A device according to claim 1, wherein the thickness gauge is configured either as a stationary thickness gauge, which measures the thickness of the plastic-film or plastic-sheet web across the entire width thereof or only in a partial area, or as a stationary thickness gauge, which is divided into several measurement zones and which measures the thickness of the plastic-film or plastic-sheet web section-wise across the entire width thereof, or the thickness gauge is configured as a thickness gauge traversing the width of the film.

18. A device according to claim 1, wherein the thickness gauge has capacitive or inductive sensors, optical sensors, sensors, which determine the distance of the film surface to a deflecting roller, or X-ray transmission sensors.

19. A device according to claim 1, wherein at least one cooling roller contacting the plastic-film or plastic-sheet web is arranged downstream of the smoothing rollers and, wherein one of the at least one thickness gauges for measuring the thickness of the plastic-film or plastic-sheet web is arranged downstream of the at least one cooling roller.

20. A device according to claim 19, wherein the controller is configured for capturing at least one of the current torque, the rotational speed or the circumferential speed of the at least one cooling roller.

21. A device according to claim 1, further comprising a stripping device configured as a stripping roller pair for stripping the plastic-film or plastic-sheet web or configured as a winding unit.

22. A device according to claim 21, wherein the controller is configured for capturing the current torque of the winding unit.
